(19) United States
(12) Patent Application Publication
(10) Pub. No.: US 2019/0229898 A1
(43) Pub. Date: Jul. 25, 2019

(54) ELECTRONIC APPARATUS, TERMINAL APPARATUS AND METHOD OF CONTROLLING THE SAME

(71) Applicant: SAMSUNG ELECTRONICS CO., LTD., Suwon-si (KR)

(72) Inventors: Hoejin KWEN, Suwon-si (KR); Soobyoung OH, Suwon-si (KR); Hyoyong JEONG, Suwon-si (KR)

(73) Assignee: SAMSUNG ELECTRONICS CO., LTD., Suwon-si (KR)

(21) Appl. No.: 16/253,962

(22) Filed: Jan. 22, 2019

(30) Foreign Application Priority Data
Jan. 22, 2018 (KR) 10-2018-0007704

(51) Int. Cl. H04L 9/08; H04W 40/12; H04W 40/24; H04W 12/00

(52) U.S. Cl. CPC H04L 9/088; H04W 40/12; H04L 67/12; H04W 12/001; H04W 40/248

(57) ABSTRACT

An electronic apparatus, a terminal apparatus, a method of controlling the same, and a computer program product thereof are provided. The electronic apparatus includes: a communicator which communicates with a terminal apparatus through a network; and a processor which receives routing information of the terminal apparatus, and based on a network key request being received from the terminal apparatus, generates a link key using the routing information, and transmits a network key encrypted with the generated link key to the terminal apparatus so that the terminal apparatus decrypts the transmitted network key with the link key based on the routing information.

### CROSS-REFERENCE TO RELATED APPLICATION

This application is based on and claims priority under 35 U.S.C. § 119 to Korean Patent Application No. 10-2018-0007704, filed on Jan. 22, 2018, in the Korean Intellectual Property Office, the disclosure of which is incorporated by reference herein in its entirety.

### BACKGROUND

### 1. Field

The disclosure relates to an electronic apparatus, a terminal apparatus, a method of controlling the same, and a computer program product thereof, and more particularly, to an electronic apparatus, a terminal apparatus, a method of controlling the same, and a computer program product thereof, in which wireless network communication is performed.

### 2. Description of Related Art

An electronic apparatus is capable of communicating with a plurality of terminal apparatuses through a wireless network. There are various standards of the wireless network, such as ZigBee, Z-Wave, Wi-Fi, Bluetooth, etc.

With recent spread of Internet of things (IoT), the use of the wireless network has also been gradually expanded. Accordingly, security in the wireless network environments has also become an important issue.

As a trust center (TC) for wireless network security, the electronic apparatus serves to distribute a network key for communication to the terminal apparatuses.

In general, the network key is transmitted as encrypted by a previously designated key between the electronic apparatus and the terminal apparatus, but has security vulnerability. In other words, it is apprehended that the key for encrypting the network key will be exposed by external hacking or the like, and thus more serious damage such as personal information leakage may arise.

### SUMMARY

In accordance with an aspect of the disclosure, an electronic apparatus, a terminal apparatus, a method of controlling the same, and a computer program product thereof are provided in which security in wireless network communication is enhanced.

According to an aspect of the disclosure, there is provided an electronic apparatus including: a communicator configured to communicate with a terminal apparatus through a network; and a processor configured to receive routing information of the terminal apparatus connected to the network, and based on a network key request being received from the terminal apparatus, generate a key based on the routing information, and transmit a network key encrypted with the generated key to the terminal apparatus so that the terminal apparatus decrypts the transmitted network key with the key based on the routing information. The processor may be configured to receive the routing information of the terminal apparatus with a first network key, and transmit a second network key as encrypted with the generated key. Thus, the network key is encrypted with the key generated based on the routing information of the terminal apparatus that wants to rejoin the wireless network, thereby enhancing security.

The processor may be configured to control the generated key to be terminated based on a response to the transmitted network key being received from the terminal apparatus. Thus, the corresponding key is not usable any more, and is thus much less likely to be leaked to the outside due to external hacking.

The received response may include updated routing information of the terminal apparatus, and the processor may be configured to control the routing information to be updated corresponding to the received response. Thus, the new network is encrypted with the key based on the updated routing information when the corresponding terminal apparatus rejoins the network, and thus security is continuously maintained.

The routing information may include link quality information about strength of a signal transmitted from and received in the terminal apparatus, and depth information about a connection state of the terminal apparatus in a tree structure of the network. The terminal apparatus may be connectable to the electronic apparatus through at least one router, and the routing information may further include identification information about the router that performs an operation to relay the terminal apparatus and the electronic apparatus. Thus, unique information of the terminal apparatus, which is not open to other apparatuses, is used as the routing information, and thus security effects are enhanced.

According to an aspect of the disclosure, there is provided a terminal apparatus including: a communicator configured to communicate with an electronic apparatus through a network; and a processor configured to transmit routing information to the electronic apparatus connected to the network, make a request for a network key to the electronic apparatus, receive the network key encrypted with a key based on the transmitted routing information from the electronic apparatus, and decrypt the received network key with the key based on the routing information. The processor may be configured to transmit the routing information with a first network key, receive a second network key encrypted with the key based on the routing information, and decrypt the second network key with the key based on the routing information. Thus, the network key is encrypted with the key generated based on the routing information of the terminal apparatus that wants to rejoin the wireless network, thereby enhancing security.

The processor may be configured to request for the second network key from the electronic apparatus based on the terminal apparatus failing to perform communication using the first network key. Thus, the terminal apparatus, to which the updated network key is not shared, automatically makes a request for the updated network key, and thus easily rejoin the network.

The processor may be configured to transmit a response to the network key to the electronic apparatus and control the key based on the routing information to be terminated, based on the network key being obtained by the decryption. Thus, the corresponding key is not usable any more, and is thus much less likely to be leaked to the outside due to external hacking.

The transmitted response may include updated routing information of the terminal apparatus. Thus, the new network is encrypted with the key based on the updated routing information when the corresponding terminal apparatus rejoins the network, and thus security is continuously maintained.

The routing information may include link quality information about strength of a signal transmitted from and received in the terminal apparatus, and depth information about a connection state of the terminal apparatus in a tree structure of the network. The terminal apparatus may be connectable to the electronic apparatus through at least one router, and the routing information may further include identification information about the router that performs an operation to relay the terminal apparatus and the electronic apparatus. Thus, unique information of the terminal apparatus, which is not open to other apparatuses, is used as the routing information, and thus security effects are enhanced.

The processor may be configured to control the terminal apparatus to connect with the electronic apparatus through a router selected based on link quality information of surrounding nodes. Thus, the terminal apparatus can properly join the network even when the connection is temporarily unstable.

According to an aspect of the disclosure, there is provided a method of controlling an electronic apparatus. The method includes: receiving routing information from a terminal apparatus connected to a network; generating a key based on the received routing information and based on a network key request being received from the terminal apparatus; and transmitting a network key encrypted with the generated key to the terminal apparatus so that the terminal apparatus decrypts the network key with the key based on the routing information. The receiving of the routing information may include receiving the routing information from the terminal apparatus with a first network key, and the transmitting of the network key may include transmitting a second network key as encrypted with the generated key. Thus, the network key is encrypted with the key generated based on the routing information of the terminal apparatus desired to rejoin the wireless network, thereby enhancing security.

The method may further include terminating the generated key based on a response to the transmitted network key being received from the terminal apparatus. Thus, the corresponding key is not usable any more, and is thus much less likely to be leaked to the outside due to external hacking.

The received response may include updated routing information of the terminal apparatus, and the method may further include updating the routing information in accordance with the received response. Thus, the new network is encrypted with the key based on the updated routing information when the corresponding terminal apparatus rejoins the network, and thus security is continuously maintained.

According to an aspect of the disclosure, there is provided a method of controlling a terminal apparatus, The method includes: transmitting routing information to an electronic apparatus connected to a network, making a request for a network key to the electronic apparatus, receiving, from the electronic apparatus, the network key encrypted with a key based on the transmitted routing information, and obtaining the network key by decrypting the received network key with the key based on the routing information. Thus, the network key is encrypted with the key generated based on the routing information of the terminal apparatus which wants to rejoin the wireless network, thereby enhancing security.

According to an aspect of the disclosure, there is provided a computer program product including: a memory configured to store an instruction and a processor. The instruction is issued to receive routing information of a terminal apparatus connected to a network, to generate a key based on the received routing information and based on a network key being request received from the terminal apparatus, and to transmit a network key encrypted with the generated key to the terminal apparatus so that the terminal apparatus decrypts the transmitted network key with the key based on the routing information. Thus, the network key is encrypted with the key generated based on the routing information of the terminal apparatus which wants to rejoin the wireless network, thereby enhancing security.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a wireless network system that includes an electronic apparatus and a terminal apparatus according to an embodiment.

FIG. 2 is a block diagram illustrating an electronic apparatus according to an embodiment.

FIG. 3 is a block diagram illustrating a terminal apparatus according to an embodiment.

FIG. 4 is a view illustrating a network structure between an electronic apparatus and a terminal apparatus according to an embodiment.

FIG. 5 is a view illustrating routing information of a terminal apparatus according to an embodiment.

FIGS. 6 and 7 are flow diagrams illustrating operations between an electronic apparatus and a terminal apparatus according to an embodiment.

FIG. 8 is a flowchart illustrating a method of controlling an electronic apparatus and a terminal apparatus according to an embodiment.

### DETAILED DESCRIPTION

Below, various embodiments will be described in detail with reference to accompanying drawings. In the drawings, like numerals or symbols refer to like elements having substantially the same function, and the size of each element may be exaggerated for clarity and convenience of description. However, the configurations and functions illustrated in the following embodiments are not construed as limiting the disclosure and the key configurations and functions. In the following descriptions, details about publicly known functions or features will be omitted if it is determined that they cloud the gist of the disclosure.

In the following description, terms ‘first’, ‘second’, etc. are only used to distinguish one element from another, and singular forms are intended to include plural forms unless otherwise mentioned contextually. In the following description, it will be understood that terms ‘comprise’, ‘include’, ‘have’, etc. do not preclude the presence or addition of one or more other features, numbers, steps, operations, elements, components, or a combination thereof. In addition, a ‘module’ or a ‘portion’ may perform at least one function or operation, be achieved by hardware, software or combination of hardware and software, and be integrated into at least one module. In the disclosure, at least one among a plurality of elements refers to not only all the plurality of elements but also both each one of the plurality of elements excluding the other elements and a combination thereof.

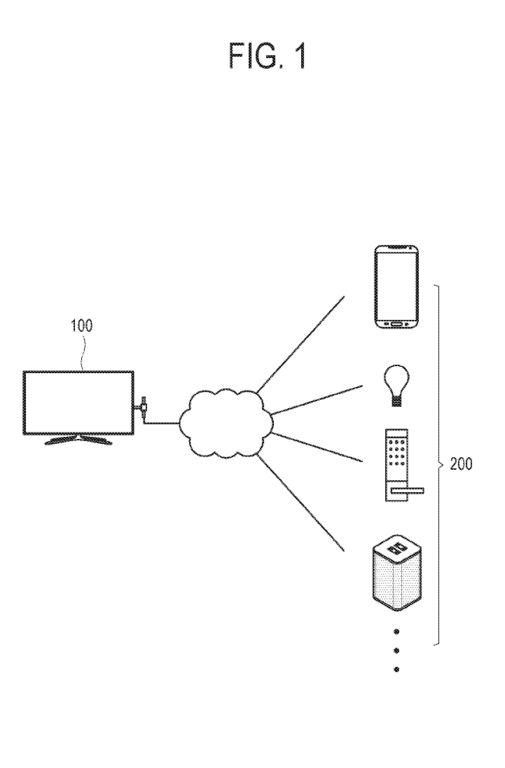

FIG. 1 is a block diagram illustrating a wireless network system that includes an electronic apparatus and a terminal apparatus according to an embodiment.

According to an embodiment, an electronic apparatus 100 may be a television (TV) or a set-top box (STB). However, the disclosure is not limited to this embodiment, and the electronic apparatus 100 may alternatively be any one of apparatuses other than the TV and the set-top box, such as a server, a hub apparatus, and a personal computer (PC) including a laptop or desktop computer. The hub apparatus refers to an apparatus used for relaying communication of a terminal apparatus 200 like a gateway, and may, for example, connect with the TV by a wire or wirelessly.

The electronic apparatus 100 performs communication with at least one terminal apparatus 200 through a network.

The terminal apparatus 200 can have an access to the electronic apparatus 100 through the network, and may include various electronic devices or digital devices provided as things or smart-things operating based on Internet of things (IoT) such as smart home, a smart car, remote reading of meter, health care, etc. The terminal apparatus 200 may include a sensor, a switch, and the like to perform the operations of the devices and sense surrounding environments. The terminal apparatus 200 according to an embodiment is not limited to the foregoing devices and may include any device capable of performing communication with the electronic apparatus 100.

According to an embodiment, the electronic apparatus 100 may be provided to perform not 1:1 communication but 1:N communication with the terminal apparatuses 200.

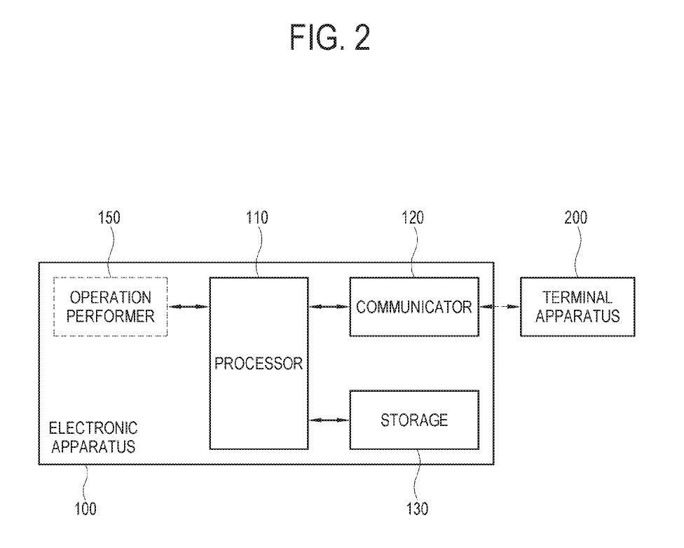

The electronic apparatus 100, which is provided with an operation performer 150 (see FIG. 2) such as a display or a loudspeaker similar to the ones provided in the TV, is capable of directly performing the functions. However, the electronic apparatus 100, which is not provided with the operation performer 150 such as the display or the loudspeaker like the set-top box, the hub apparatus or the server, is not capable of directly performing the functions.

The electronic apparatus 100, which is not capable of directly performing the functions, may indirectly perform the functions through another apparatus, e.g. the TV, the PC, the terminal apparatus 200, or the like. The following descriptions about the electronic apparatus 100 may include both the electronic apparatus 100 that operates independently and the electronic apparatus 100 that operates including another connected apparatus.

Below, configurations of the electronic apparatus 100 and the terminal apparatus 200 will be described according to various embodiments.

FIG. 2 is a block diagram illustrating an electronic apparatus according to an embodiment.

As shown in FIG. 2, the electronic apparatus 100 includes a processor 110, a communicator 120, and a storage 130. In addition to the processor 110, the communicator 120 and the storage 130, the electronic apparatus 100 may further include an operation performer 150. However, the configuration of the electronic apparatus 100 shown in FIG. 2 is merely an example, and the electronic apparatus 100 according to an embodiment may have a different configuration from that shown in FIG. 2. That is, the electronic apparatus 100 according to an embodiment may include another element in addition to the elements of FIG. 2. For example, the electronic apparatus 100 may additionally include a user input unit for receiving a user's input like a remote controller, a video processor for processing a video signal, etc. or may exclude some elements, for example, the operation performer, from the elements of FIG. 2.

The communicator 120 may communicate with the terminal apparatus 200 under control of the processor 110. The communicator 120 may perform communication using one or more of various communication methods. For example, the communicator 120 may be configured to perform communication based on at least one communication method among many communication methods including ZigBee, Z-Wave, Wi-Fi, Bluetooth, Ultra-Wide Band (UWB), Wireless USB, and near field communication (NFC).

In the electronic apparatus 100 according to an embodiment, the communicator 120 is a ZigBee or Z-Wave communication module that consumes low power, so that communication between the electronic apparatus 100 and the terminal apparatus 200 can be performed through the wireless network. The communicator 120 may be a network card or a hardware component for implementing various communication methods.

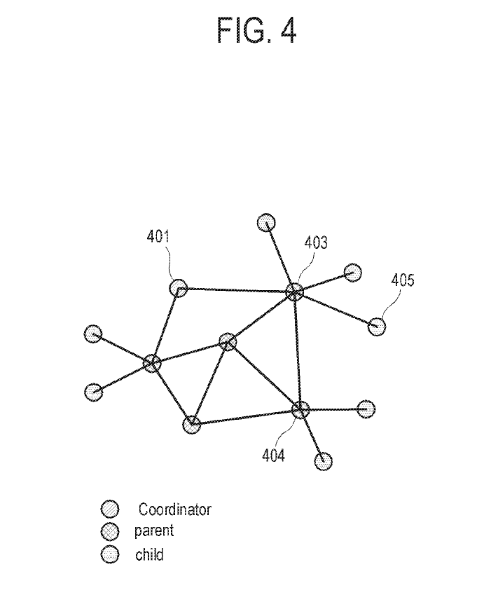

According to an embodiment, the communicator 120 may function as a coordinator of FIG. 4 to be described in further detail below. According to an alternative embodiment, the communicator 120 may not function as the coordinator, and a different element of the electronic apparatus 100 may function as the coordinator under control of the processor 110. This different element may be included in the electronic apparatus 100, or may be an external element connected through the connector of the electronic apparatus 100.

The storage 130 may be configured to store various pieces of data of the electronic apparatus 100. The storage 130 may be a nonvolatile memory (or a writable read only memory (ROM) which can retain data even though the electronic apparatus 100 is powered off, and mirror changes. That is, the storage 130 may be provided as one among a flash memory, electrically programmable ROM (EPROM) or electrically erasable and programmable ROM (EEPROM). The storage 130 may further include a volatile memory, such as a dynamic random access memory (DRAM) or static RAM (SRAM), of which reading or writing speed is faster than the nonvolatile memory.

Data stored in the storage 130 may, for example, include not only an operating system for driving the electronic apparatus 100 but also various applications executable on the operating system, image data, appended data, etc.

Specifically, the storage 130 may be configured to store a signal or data input/output corresponding to operations of elements under control of the processor 110. The storage 130 may be configured to store a control program for controlling the electronic apparatus 100, a user interface (UI) related to an application provided by a manufacturer or downloaded from the outside, images for providing the UI, user information, a document, a database, or the related data.

According to an embodiment, the storage 130 is configured to store a pre-configured link key generated at a point in time when a network is installed. Further, the storage 130 is configured to store routing information of the terminal apparatus 200 capable of communicating with the network.

According to an embodiment, the term ‘storage’ is defined to include the storage 130, the ROM and RAM provided as the memories in which a program to be executed by the processor 110 is stored or loaded, or a memory card (not shown) mountable to the electronic apparatus 100 (for example, a micro secured digital (SD) card, a memory stick).

The electronic apparatus 100 may further include the operation performer 150. The operation performer 150 is an element for performing an operation or a function of the electronic apparatus 100 under the control of the processor 110, and may include a display, a loudspeaker, a vibration device, or a similar outputter. The operation performer 150 may output an image or a sound through the device or the outputter. The operation performer 150 is not limited to these elements, and may further include an element for performing another operation.

The processor 110 performs control for operating general elements of the electronic apparatus 100.

Specifically, the processor 110 encrypts an initial network key with the pre-configured link key and provides the initial network key to the terminal apparatus 200 in response to an association request received from the terminal apparatus 200 at a point in time when the network is installed. Further, when a predetermined terminal apparatus 200 makes a request for rejoining the network, the processor 110 generates a key based on the routing information of the storage 130, encrypts a current network key with the generated key and provides the encrypted network key to the terminal apparatus 200. Here, the rejoining request may include a message for requesting an updated new network key.

The processor 110 may include at least one processor for executing a control program (or instructions) for performing such control operations, and at least one processor for executing the loaded control program, i.e. at least one of a central processing unit (CPU), a microprocessor or an application processor (AP). The control program is installed in the nonvolatile memory, i.e. ROM, and at least a part of the installed control program is loaded to the volatile memory, i.e. the RAM) so as to be executed. The processor, the ROM, and the RAM are connected to one another through an internal bus.

The processor may include a single core, a dual core, a triple core, a quad core, and the like multiple core. According to an embodiment, the processor may include a plurality of processors, for example, a main processor and a sub processor that operates in a sleep mode (during which the electronic apparatus receives only standby power and does not operate).

According to an embodiment, when the electronic apparatus 100 is a computer, the processor 110 may further include a graphic processing unit (GPU) for a graphic process.

Further, according to another embodiment, when the electronic apparatus 100 is a digital TV, a single processor may be provided. For example, the processor may be achieved by a system on chip (SoC) where the core and the GPU are coupled.

In an embodiment, the processor 110 may be included in a main SoC mounted to a built-in printed circuit board (PCB) of the electronic apparatus 100.

The control program may include a program(s) achieved by at least one of a basic input/output system (BIOS), a device driver, an operating system, a firmware, a platform, or an application. According to an embodiment, the application may be previously installed or stored in the electronic apparatus 100 when the electronic apparatus 100 is manufactured, or may be installed in the electronic apparatus 100 based on application data received from the outside when it is required in the future. The application data may, for example, be downloaded from an external server such as an application market to the electronic apparatus 100.

Such an external server is merely an example of the computer program product according to an embodiment, but is not limited thereto.

That is, according to an alternative embodiment, the foregoing operations of the processor 110 may be implemented by a computer program stored in the computer program product (not shown) provided separately from the electronic apparatus 100. In this case, the computer program product includes a memory in which an instruction corresponding to a computer program is stored, and a processor. When the instruction is executed by the processor, a dynamic link key based on the routing information of the corresponding terminal apparatus is generated in response to a new network key request from the terminal apparatus, the network key encrypted by the generated dynamic link key is transmitted to the terminal apparatus.

Accordingly, the electronic apparatus 100 downloads and executes the computer program stored in a separate computer program product and performs the operations of the processor 110.

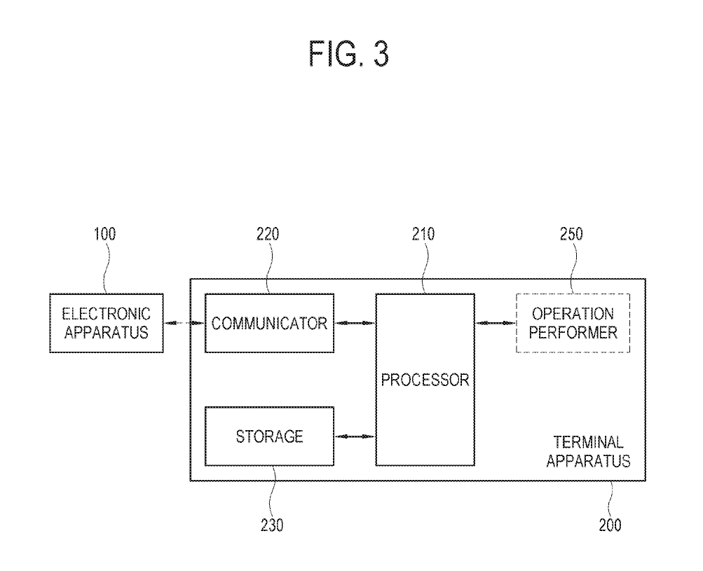

FIG. 3 is a block diagram illustrating a terminal apparatus according to an embodiment.

As shown in FIG. 3, the terminal apparatus 200 includes a processor 210, a communicator 220 and a storage 230. In addition to the processor 210, the communicator 220, and the storage 230, the terminal apparatus 200 may further include an operation performer 250.

The operation performer 250 refers to an element that performs operations or functions of the terminal apparatus 200 under control of the processor 210, and may include a sensor or a switch. The operation performer 250 is not limited to the foregoing configuration, and may further include another element for performing different operations.

The processor 210, the communicator 220, the storage 230, and the operation performer 250 of the terminal apparatus 200 shown in FIG. 3 are similar to the processor 110, the communicator 120, the storage 230, and the operation performer 150 of the electronic apparatus 100 described in FIG. 2, in which the same terms are given to the elements for performing analogous operations, and repetitive descriptions thereof will be omitted.

It will be appreciated that the following operations related to generation of the key for encryption and transmission/reception of the network key using the same are performed by the processor 110 of the electronic apparatus 100 or the processor 210 of the terminal apparatus 200.

FIG. 4 is a view illustrating a network structure between an electronic apparatus and a terminal apparatus according to an embodiment.

It will be described that the network structure shown in FIG. 4 includes a ZigBee-based mesh network.

According to an embodiment, the electronic apparatus 100 operates as a manager, i.e. a coordinator 401 for forming and controlling a network, and the processor 110 may serve as a trust center (TC) for network security.

The processor 110 performs generation (or issue), division (or distribution), management, and the like of the key for the encryption in the network security. Specifically, the processor 110 may manage all the keys of the network, periodically update the keys, and transmit the updated keys to the terminal apparatuses 200 of nodes associated with the network. Further, the TC checks a security key from a packet received from each node, and determines whether to allow the corresponding terminal apparatus 200 to join the network. According to an embodiment, the key issued by the TC is encrypted by a counter with CBC-MAC (CCM) protocol using 128-bit advanced encryption standard (AES) algorithms.

The processor 110 performs packet encryption in two layers in order to reinforce the security. A key used in a network layer between the two layers will be called the network key, and a key used in an application layer will be called an application link key or the link key. That is, according to an embodiment, the encryption is performed using the separate keys according to the two layers.

The electronic apparatus 100 and the terminal apparatus 200 associated with the network employ the network key for communication with each other.

According to an embodiment, the processor 110 periodically updates the network key in order to keep the security high, and the updated network key is encrypted by the link key and distributed from the electronic apparatus 100 to the terminal apparatus 200. When the network key is updated, the existing network keys as well as a network key issued at a point in time when the network is installed (hereinafter, referred to as the initial network key) are invalid, and the terminal apparatus 200 periodically performs communication with the electronic apparatus 100 and obtains the updated network key.

Although the terminal apparatus 200 has joined the network but does not obtain the newest updated network key, the terminal apparatus 200 may again be subjected to verification for joining the network. In this case, the terminal apparatus 200 makes a request for a valid latest network key to the electronic apparatus 100.

That is, according to an embodiment, the terminal apparatus 200 is controlled to share the updated network key while continuously keeping association with the electronic apparatus 100 that serves as the TC.

According to an alternative embodiment, the processor 110 does not update the network key, and the terminal apparatus 200 is controlled to use the network key having a predetermined value to perform communication with the electronic apparatus 100. In this case, the terminal apparatus 200 may be disconnected from the network, or the terminal apparatus 200 that has lost the network key may transmit a network rejoining request message.

The link key according to an embodiment may include a pre-configured link key (hereinafter, referred to as a “setting link key”) for encrypting the network key distributed when the network is installed, and a dynamic link key for encrypting the network key distributed after the network is installed. The dynamic link key is generated using the routing information (to be described in further detail later) as a parameter. According to an embodiment, the network key distributed after the network is installed is a new updated network key different from the initial network key.

The setting link key is determined based on the standards for interworking expandability and usability between the apparatuses. The setting link key is generated in each of the electronic apparatus 100 and the terminal apparatus 200 at a point in time when the network is installed, and ensures security between the electronic apparatus 100 and the terminal apparatus 200 based on end-to-end security applied without being decrypted or changed in protocol by an intermediate node during the transmission. That is, an intermediate hop cannot perform decryption while the initial network key encrypted by the setting link key is routed, and thus security is maintained between a source node and a destination node.

According to an embodiment, in response to the first association request (or joining request) from a predetermined terminal apparatus 200, the TC encrypts the initial network key with the setting link key, and transmits the encrypted initial network key to the corresponding terminal apparatus 200.

According to an embodiment, in response to a network rejoining request from a specific terminal apparatus 200, the dynamic link key is generated to be temporarily used based on the routing information of the corresponding terminal apparatus 202. Here, the terminal apparatus 200 that transmits the rejoining request refers to an electronic apparatus 100 that has not normally received a periodically updated new network key or has failed many times in transmitting a command based on the existing network key, and the rejoining request includes a message for requesting a new (or valid) network key.

The electronic apparatus 100, i.e. the coordinator 401 encrypts the new network key with a generated dynamic link key and transmits the encrypted new network key to the corresponding electronic apparatus 200, and the corresponding dynamic link key is terminated and not usable any more when the new network key is normally transmitted. For example, terminating the dynamic link key may include deleting the dynamic link key.

The TC, i.e. the electronic apparatus 100 serving as the coordinator 401 is assigned with identification information, i.e. an extended pan identification (EPID). The EPID refers to a 64-bit network address, and the terminal apparatus 200 is controlled to join the network based on the EPID. The EPID is generated at a point in time when the network is installed, and shared between all the nodes of the network.

A parent node 403 performs routing for network communication. A child node 405 may transmit and receive a message to and from the coordinator 401 through the parent node 403. As identification information, a media access control (MAC) address is assigned to the terminal apparatus 200 that operates as the parent node or the child node. The MAC address may have a length of 48 bits based on the standards of institute of electrical and electronics engineers (IEEE).

According to an embodiment, the EPID and the MAC address are included in the routing information.

According to an embodiment, the terminal apparatus 200 may operate as the parent node 403 or the child node 405. Hereinafter, the terminal apparatus operating as the parent node 403 will be called a router, and the terminal apparatus operating as the child node 405 will be called an end device.

In the foregoing network according to an embodiment, the router may be a terminal apparatus that operates with commercial electric power, and the end device may be a terminal apparatus that operates with a battery. For example, the end device may be actualized by a door sensor, a motion sensor, etc. According to an embodiment, the end device 405 can operate in a sleep mode to reduce power consumption, and be periodically woken up from the sleep mode.

The child node 405 joins the network by selecting a certain router as the parent node 403 in accordance with network environments. Here, routing may be determined based on a link cost or the like quality information between surrounding nodes, i.e. a link quality index (LQI). The LQI shows strength, e.g. a frequency of a signal transmitted and received between the nodes, and may have one of values from 0x00 to 0xFF in accordance with the network environments.

Here, the LQI is included in the routing information, and is stored as synchronized in each of the electronic apparatus 100 and the terminal apparatus 200 at a point in time when data transmission/reception between the electronic apparatus 100 and the terminal apparatus 200, for example transmission/reception of a request message and a corresponding response message is completed.

When the LQI is the highest between a predetermined terminal apparatus and the TC, i.e. the coordinator 401, the corresponding node may be directly connected to the coordinator 401.

The terminal apparatus 300 may have a depth level corresponding to an associated state of a corresponding node in a network tree structure. For example, the terminal apparatus 300 serving as the router, i.e. a node directly connected to the coordinator 401 has a depth level of ‘1’. The depth level of the terminal apparatus 300 is involved in the routing information, and is stored as synchronized in each of the electronic apparatus 100 and the terminal apparatus 200 at a point in time when the data transmission/reception between the electronic apparatus 100 and the terminal apparatus 200, for example the transmission/reception of the request message and the corresponding response message is completed.

According to an embodiment, the child node 405 that has joined the network through the parent node 403 may rejoin the network through a new parent node 404 in accordance with network environments. For example, when the end device corresponding to the child node 405, i.e. the terminal apparatus 200 is waken up from the sleep mode, but the LQI with the existing parent node 403 is too low to perform the communication, the corresponding apparatus 200 needs a new parent node that provides stable network environment. The terminal apparatus 200 of the corresponding child node 405 selects the parent node 404 having the highest LQI as a new parent node among the surrounding nodes, and transmit a rejoining request message to the coordinator 401.

According to an alternative embodiment, the child node 405 may rejoin the network through the previously associated parent node 403. In this case, the parent node 403 has the LQI corresponding to stable network communication.

According to an embodiment, the coordinator 401, i.e. the electronic apparatus 100 is provided to store and manage the routing information of the terminal apparatuses 200, i.e. all the nodes that has joined the network. The stored routing information is utilized as a parameter for generating the dynamic link key when the rejoining request is received from the terminal apparatus 200 in the future.

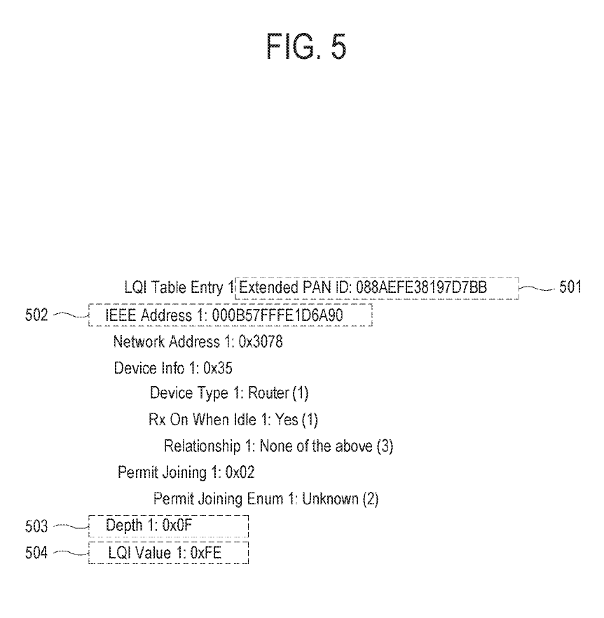

FIG. 5 illustrates an example of routing information of a terminal apparatus according to an embodiment.

FIG. 5 shows an example of the routing information of the terminal apparatus 200 corresponding to a child node 503 connected to the coordinator 401 through a predetermined router, i.e. a parent node 502.

As shown in FIG. 5, the routing information includes identification information, i.e. EPID 501 of the electronic apparatus 100 that operates as the TC, i.e. the coordinator 401, and identification information, i.e. a MAC address 502 of the router that operates as a relay between the terminal apparatus 200 and the electronic apparatus 100.

According to an alternative embodiment, when the node of the terminal apparatus 200 is directly connected to the coordinator 401, the routing information does not include the identification information of the router.

According to an embodiment, the routing information of the terminal apparatus 200 further includes depth information 503 and link quality information 504 as shown in FIG. 5. The depth information 503 has a predetermined value that shows an associated state (e.g. a signal strength) of surrounding nodes with respect to the coordinator 401 in the network tree structure of FIG. 4.

According to an embodiment, the electronic apparatus 100 and the terminal apparatus 200 are controlled to store the routing information in sync with each other at a point in time when the data transmission/reception e.g. the transmission/reception of the request message and the corresponding response message is normally completed between them.

That is, the terminal apparatus 200 is controlled to share the updated network key while continuously maintaining the association with the TC, i.e. the electronic apparatus 100, during which the data is transmitted and received between the terminal apparatus 200 and the electronic apparatus 100. The electronic apparatus 100 is synchronized by receiving the depth information 503 and the link quality information 504 shared as the routing information from the terminal apparatus 200 in the newest data transmission/reception. Here, when the node of the terminal apparatus 200 is the child node 405 associated with the coordinator 401 through a predetermined parent node 403, the routing information to be synchronized further includes the identification information of the router corresponding to the parent node 403. The routing information further includes the identification information of the coordinator 401, i.e. the electronic apparatus 100, and the identification information of the electronic apparatus 100 is information shared between the nodes of the network.

As described above, according to an embodiment, the synchronized routing information refers to information that is not open to an element or device (node) other than the network including the electronic apparatus 100 and the corresponding terminal apparatus 200. Therefore, a message, i.e. a packet including a new network key encrypted by the dynamic link key generated based on the routing information is not decrypted by a hacker even though it is sniffed by hacking, and thus security for the new network key is maintained.

The network structure between the electronic apparatus 100 and the terminal apparatus 200 according to the disclosure is not limited to the mesh structure shown in FIG. 4, and may be configured in different forms from the foregoing connection structure. For example, the network may have a star structure where a plurality of terminal apparatuses is directly connected to one coordinator, or a cluster tree structure where a router or an end device is directly or indirectly connected to the coordinator.

Below, control operations performed in the electronic apparatus 100 and the terminal apparatus 200 will be described according to an embodiment.

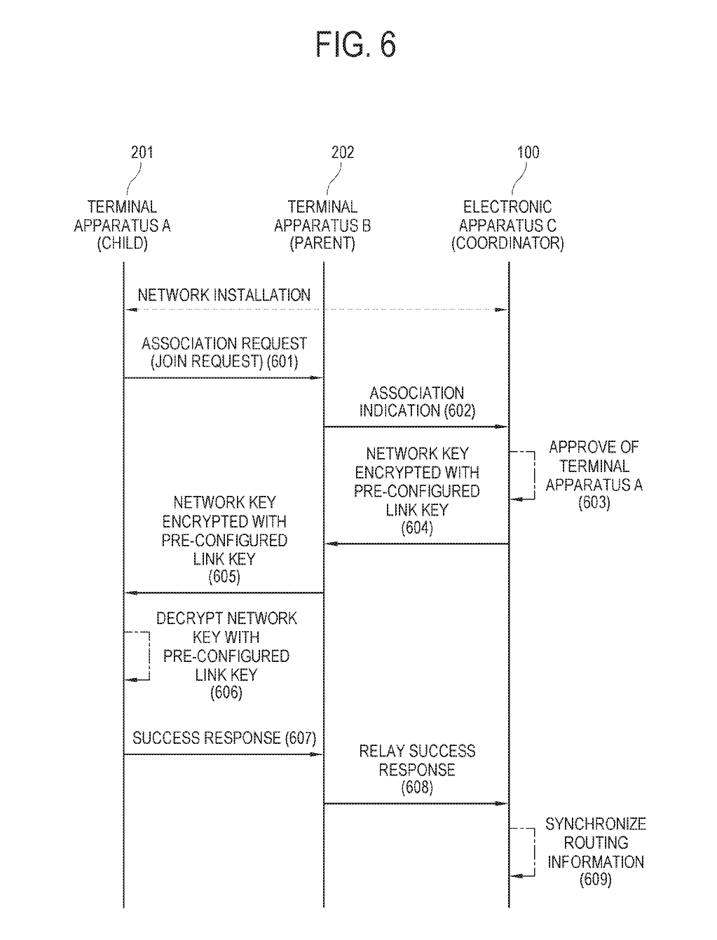

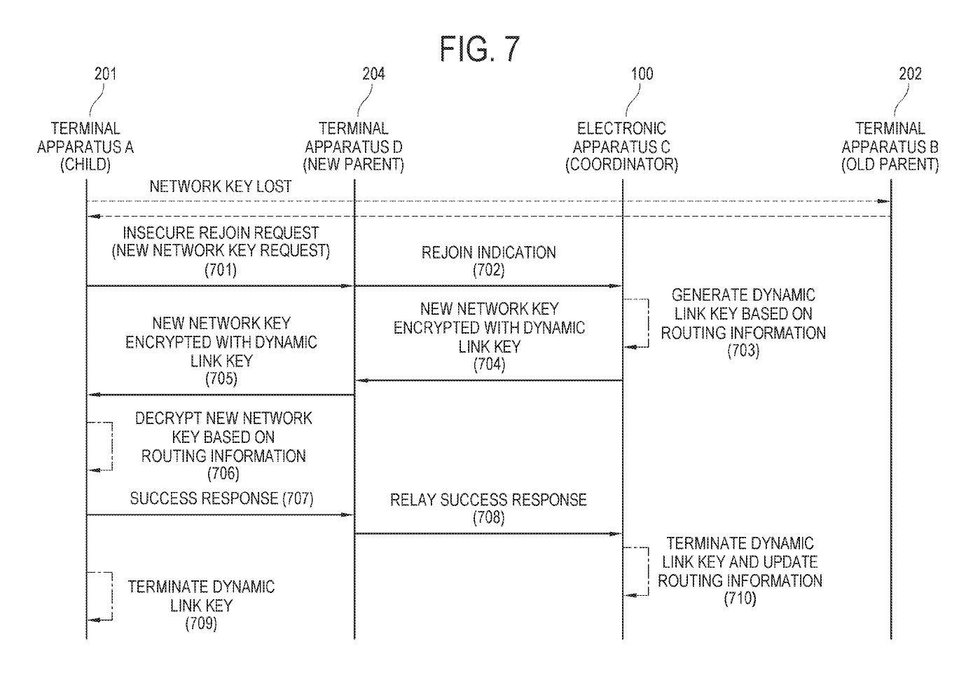

FIGS. 6 and 7 are flowcharts illustrating operations between an electronic apparatus and a terminal apparatus according to an embodiment. FIG. 6 shows operations of when the network is installed and FIG. 7 shows operations of when the network key is updated.

In FIGS. 6 and 7, a terminal apparatus A 201, a terminal apparatus B 202, and a terminal apparatus C 204 are equivalent to the terminal apparatuses 200 according to embodiments shown in FIGS. 1 and 3, and an electronic apparatus C 100 is equivalent to the electronic apparatus 100 according to embodiments shown in FIGS. 1 and 2. Further, in the wireless network of FIGS. 6 and 7, the electronic apparatus C 100 serves as the coordinator 401 of FIG. 4, the terminal apparatus A 201 serves as the child node 405, and the terminal apparatus B 202 and the terminal apparatus D 204 respectively serve as the parent nodes 403 and 404 of the terminal apparatus A 201.

As shown in FIG. 6, the terminal apparatus A 201 transmits a message for an association request (or a joining request) (hereinafter, referred to as association request message or a joining request message) while installing the network including the electronic apparatus C 100, the terminal apparatus A 201 and the terminal apparatus B 202 (601). According to an embodiment, the joining request message is encrypted by a setting link key (or a pre-configured link key), in which the apparatuses (the terminal apparatus A 201, the terminal apparatus B 202, and the electronic apparatus C 100) used in the wireless network of the disclosure have the setting link key in common to interwork with one another.

The terminal apparatus B 202 transmits an association indication message, which informs that the joining request is received from the terminal apparatus A 201, to the electronic apparatus C 100 (602). According to an embodiment, the terminal apparatus B 202 forwards the joining request message, received from the terminal apparatus A 201, to the electronic apparatus C 100, and this forwarded message is the association indication message.

The electronic apparatus C 100 performs authentication for determining whether to approve of the terminal apparatus A 201 joining the network (603). Here, the electronic apparatus C 100 verifies the setting link key obtained by encrypting the received message, and thus authenticates the terminal apparatus A 201.

According to an embodiment, the electronic apparatus C 100 may perform primary authentication based on the setting link key and then perform secondary authentication based on input of the installation code. The installation code may for example be input by a user or installer's button control in each of the terminal apparatus A 201 and the electronic apparatus C 100. Here, the secondary authentication based on the installation code is performed under observation of a network installer or administrator, and the administrator determines allowance or disallowance in the electronic apparatus C 100 when the secondary authentication is triggered by button control.

When the terminal apparatus A 201 is authenticated, the electronic apparatus C 100 transmits a message, which includes the network key encrypted by the setting link key, to the terminal apparatus B 202 (604).

The terminal apparatus B 202 forwards the message, which is received from the electronic apparatus C 100 and includes the encrypted network key, to the terminal apparatus A 201 (605). Here, the network key included in the transmitted message may be the initial network key that is valid only when the network is installed.

The terminal apparatus A 201 decrypts the message received by the setting link key, and thus obtains the network key (606).

The terminal apparatus A 201 transmits a success response message, which informs that the network key is normally obtained, to the terminal apparatus B 202 (607). Here, the success response message is transmitted as encrypted with the obtained network key, and include the depth information and the link quality information as the routing information of the terminal apparatus A 201.

The terminal apparatus B 202 relays, i.e. forwards, the received success response message to the electronic apparatus C 100 (608).

The electronic apparatus C 100 stores the routing information of the terminal apparatus A 201 corresponding to the success response message of the terminal apparatus A 201, thereby synchronizing with the routing information of the terminal apparatus A 201 (609). Such synchronized routing information may be utilized in generating the dynamic link key for encrypting the new network key when the rejoining request message is received from the terminal apparatus A 201 in the future. In this regard, detailed descriptions will be made with reference to FIG. 7.

According to an embodiment shown in FIG. 6, the setting link key is used at a point in time when the network is installed, and therefore usability and expandability are maintained with regard to the standards.

FIG. 6 is a flow diagram illustrating the terminal apparatus A 201 employing its own parent node, i.e. the terminal apparatus B 202 to transmit and receive the message to and from the TC, i.e. the electronic apparatus C 100 according to an embodiment, but the disclosure includes an embodiment where the terminal apparatus 200 directly transmit and receive a message to and from the TC, i.e. the electronic apparatus 100. As described above, in an embodiment showing the direct connection with the electronic apparatus 100, the router is not used to forward the message, so that the joining request message from the terminal apparatus 200 in the operation 601 can be directly transmitted to the electronic apparatus 100, and the message including the network key from the electronic apparatus 100 in the operation 604 can be directly transmitted to the terminal apparatus 200.

The transmission/reception of the message for installing the network described in FIG. 6 is performed with regard to not only the terminal apparatus A 201 but also all the terminal apparatuses 200 within the network. For example, the terminal apparatus B 202 also transmits the joining request message to the electronic apparatus C 100, and thus receives the message including the network key from the electronic apparatus C 100, thereby obtaining the network key. Further, the electronic apparatus C 100 stores the routing information corresponding to the success response message of the terminal apparatus B 202.

When the network is completely installed through the foregoing operations, the electronic apparatus C 100 may perform data communication by transmitting and receiving the message based on the network key to and from the terminal apparatuses 201 and 202. Further, the electronic apparatus C 100 periodically updates the network key and transmits the updated network key to the terminal apparatuses 201 and 202, thereby enhancing the security of the wireless network.

Referring to FIG. 7, the terminal apparatus A 201 may not receive the updated network key, i.e. lose the network key, in the network where the terminal apparatus A 201 is being connected to the electronic apparatus C 100 through the terminal apparatus B 202.

There are various different causes of losing the network key, and the network key may be lost by not only simple instability of the network but also network disturbance due to hacking. For example, a hacker device may maliciously handle network traffic to cause interference, make unstable connection between the child node, i.e. the terminal apparatus A 201 and the parent node, i.e. the terminal apparatus B 202 so that the terminal apparatus A 201 cannot receive the updated network key, and then attempt hacking by sniffing a packet including a rejoining request for a new network key from the terminal apparatus A 201. Because a point in time when such rejoining request is made from the terminal apparatus A 201 is not specified, it is difficult for a user (or administrator) to intervene in and cope with the rejoining requests one by one.

Further, the terminal apparatus A 201 may enter the sleep mode to reduce power consumption on a predetermined cycle. When the network key is updated during the sleep mode of the terminal apparatus A 201, the terminal apparatus A 201 has to make a request for the new network key to the electronic apparatus C 100 after waking up from the sleep mode.

According to an embodiment, the terminal apparatus A 201 waken up from the sleep mode first tries making the rejoining request by preferentially using the existing network key that has been previously known. However, when the rejoining request based on the existing network key is failed, the terminal apparatus A 201 transmits an unsecured rejoining request message to be described later. Such failure of the rejoining request may be caused by packet loss due to an unstable network, disapproval of the electronic apparatus C 100 due to a mismatch of a network key, etc.

Here, the lost network key may be the initial network key generated when the network is installed as described in FIG. 6, or may be the network key normally transmitted from the electronic apparatus C 100 to the terminal apparatus A 201 as periodically updated after the installation.

Therefore, an embodiment to be described below with reference to FIG. 7 will be described on the assumption that the terminal apparatus A 201 obtains no valid network key currently used in the wireless network. According to an embodiment, the valid network key may be the newest network key based on update, when the electronic apparatus C 100 periodically updates the network key. According to an alternative embodiment, the valid network key may be the network key previously shared to the terminal apparatus A 201, when the electronic apparatus C 100 does not update the network key.

As shown in FIG. 7, a message for a rejoining request (hereinafter, referred to as a reassociation request message or a rejoining request message) is transmitted from the terminal apparatus A 201 that has lost the network key (701).

According to an embodiment, the terminal apparatus A 201 may transmit the rejoining request message to the new parent node, i.e. the terminal apparatus D 204 on the basis of link quality information of surrounding nodes. That is, when the network key is not normally updated due to instability of the network between the terminal apparatus A 201 and a previous parent node (or an old parent node), i.e. the terminal apparatus B 202, the terminal apparatus A 201 needs a stable new parent node, and selects the terminal apparatus D 204, the LQI of which is the highest, among the surrounding nodes as the new parent node. According to an alternative embodiment, when a connection condition between the terminal apparatus A 201 and the terminal apparatus B 202 is good, the terminal apparatus A 201 may select the terminal apparatus B 202 to be continuously maintained as the parent node.

According to an embodiment, the rejoining request message of ‘701’ may be transmitted as an unsecured (or insecure) packet.

According to an alternative embodiment, the terminal apparatus A 201 first transmits an unsecured beacon request message for obtaining a channel to exchange a message with the terminal apparatus D 204, receives a response of a beacon message from the terminal apparatus D 204, and transmits the joining request message after obtaining the channel between the terminal apparatus A 201 and the terminal apparatus D 204.

The terminal apparatus D 204 transmits an association indication (or rejoin indication) message, which indicates the rejoining request received from the terminal apparatus A 201, to the electronic apparatus C 100 (702).

According to an embodiment, the terminal apparatus D 204 forwards the rejoining request message received from the terminal apparatus A 201 to the electronic apparatus C 100, and this forwarded message is used as the association indication message.

According to an alternative embodiment, the terminal apparatus D 204 encrypts the received joining request message with the network key, which has been previously known, and transmits the encrypted message to the electronic apparatus C 100, and this encrypted joining request message is used as the association indication message. That is, the terminal apparatus D 204 normally receives the updated new network key from the electronic apparatus C 100, and is therefore capable of transmitting and receiving a message based on the verified network key.

The electronic apparatus C 100 generates the dynamic link key based on the routing information of the terminal apparatus A 201 (703). The electronic apparatus C 100 generates the dynamic link key by using the routing information 501-504 shown in FIG. 5 as parameters. Here, the depth information 503 and the link quality information 504 of the terminal apparatus A 201 are obtained from the newest transmitted/received message and synchronized between the terminal apparatus A 201 and the electronic apparatus C 100.

The electronic apparatus C 100 encrypts the updated new network key with the dynamic link key generated as described above, and transmits a message including the encrypted new network key to the terminal apparatus D 204 (704). Here, according to an alternative embodiment, the electronic apparatus C 100 encrypts the dynamic link key generated in ‘703’ with the network key that has been previously known, and transmits the encrypted dynamic link key to the terminal apparatus D 204. That is, the terminal apparatus D 204 normally receives the updated new network key from the electronic apparatus C 100, and is therefore capable of transmitting and receiving a message based on the verified network key.

The terminal apparatus D 204 forwards a message including the encrypted new network key received from the electronic apparatus C 100 to the terminal apparatus A 201 (705).

The terminal apparatus A 201 decrypts the received message with the dynamic link key based on the routing information, and thus acquires the new network key (706). Because the terminal apparatus A 201 has known the routing information used as the parameters when the electronic apparatus C 100 generates the dynamic link key, the message encrypted by the dynamic link key is decrypted to thereby normally obtain the new network key.

The terminal apparatus A 201 transmits a success response message, which indicates that the network key is normally obtained, to the terminal apparatus D 204 (707). Here, the success response message is transmitted as encrypted with the obtained new network key, and involves the depth information and the link quality information as the newest routing information of the terminal apparatus A 201.

The terminal apparatus D 204 relays, i.e. forwards the received success response message to the electronic apparatus C 100 (708).

When the success response message is transmitted, the terminal apparatus A 201 terminates the corresponding dynamic link key (709).

Likewise, when the success response message is received from the terminal apparatus D 204, the electronic apparatus C 100 terminates the generated dynamic link key, and updates the routing information of the terminal apparatus A 201 to correspond to the received success response message (710). The routing information synchronized by the update may be utilized in generating the dynamic link key for encrypting the new network key when the rejoining request message is received again from the terminal apparatus A 201 in the future.

According to an embodiment, the dynamic link key may be generated to include the information terminated in ‘703’. For example, the dynamic link key may be set to have a use period, be valid only when it is transmitted to a specific terminal apparatus, or be valid only when a specific network key is transmitted. The dynamic link key may be automatically discarded corresponding to termination information included in the key, or may be discarded under control of the electronic apparatus 100 and the terminal apparatus 200.

According to a foregoing embodiment shown in FIG. 7, the dynamic link key is generated using the routing information of each node, and the generated dynamic link key is immediately terminated based on the use period, thereby decreasing memory use of the terminal apparatuses 201, 202 and 204 in the network because there are no needs of separate memory allocation for storing the link key in each node.

FIG. 7 is a flow diagram illustrating the terminal apparatus transmitting and receiving a message to and from the TC, i.e. the electronic apparatus C 100 through a new parent node, i.e. the terminal apparatus D 204, according to an embodiment, but the disclosure includes the terminal apparatus 200 associated with the electronic apparatus 100 or directly transmitting or receiving a message to and from the electronic apparatus 100 through another terminal apparatus. In an embodiment where the terminal apparatus A 201 is directly connected to the electronic apparatus 100, without forwarding the message through the router, the rejoining request message from the terminal apparatus 200 in ‘701’ is directly transmitted to the electronic apparatus 100 and the message including the new network key from the electronic apparatus 100 in ‘704’ is directly transmitted to the terminal apparatus 200.

The foregoing operations described with reference to FIGS. 6 and 7 are an example of data transmission/reception procedures between the electronic apparatus 100 and the terminal apparatus 200, and the order thereof is not limited to that shown in FIGS. 6 and 7. Alternatively, two or more operations may be simultaneously performed, or one operation may be performed leaving a predetermined period of time.

Below, a network communication control method performed in the electronic apparatus and the terminal apparatus according to an embodiment will be described with reference to the accompanying drawings.

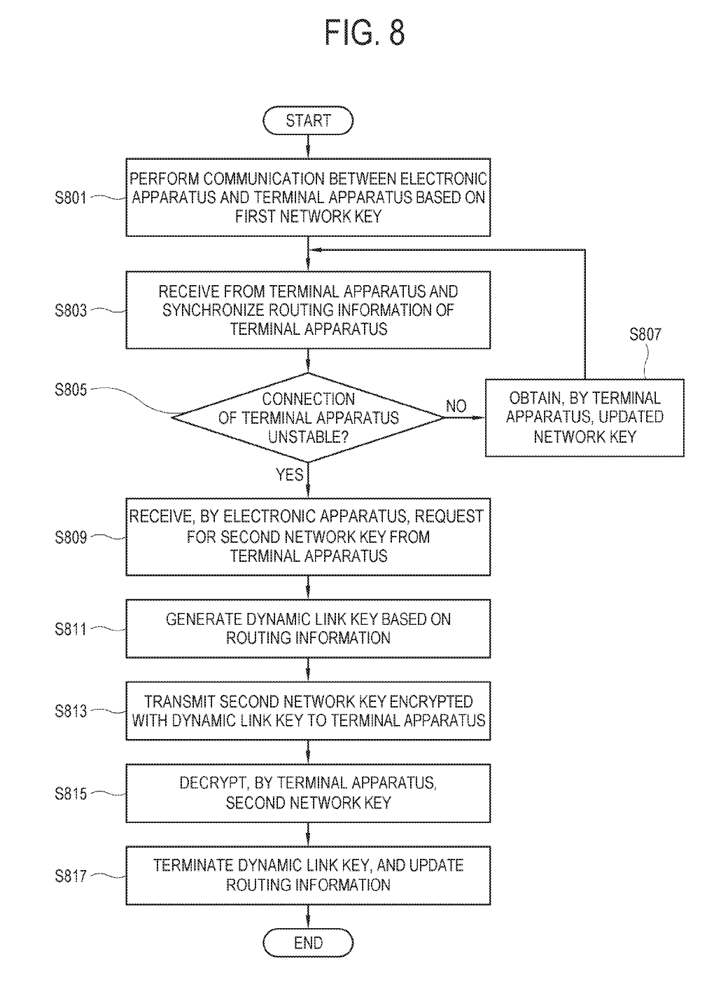

FIG. 8 is a flowchart illustrating controlling an electronic apparatus and a terminal apparatus according to an embodiment.

According to an embodiment, as shown in FIG. 8, communication between the electronic apparatus 100 and the terminal apparatus 200 is performed based on the first network key (S801). Here, as described with reference to FIG. 6, the first network key may be an initial network key generated when the network is installed, or a network key transmitted from the electronic apparatus 100 to the terminal apparatus 200 as the network key is periodically updated after installing the network.

The electronic apparatus 100 using the first network key to perform communication receives and stores the routing information from the terminal apparatus 200, thereby synchronizing the routing information of the terminal apparatus 200 (S803). Here, the routing information may be transmitted to the electronic apparatus C 100 as included in the success response message received from the terminal apparatus 200 in response to normal reception of the first network key.

In operations S801 and S803, the terminal apparatus 200 performs communication with the electronic apparatus 100 through the router, i.e. another terminal apparatus, or performs communication as directly connected to the electronic apparatus 100.

Meanwhile, the terminal apparatus 200 may have unstable connection during the foregoing network communication between the electronic apparatus 100 and the terminal apparatus 200 (S805). Here, the unstable connection may occur by various causes such as the terminal apparatus 200 itself, change in surrounding network environments, malicious external hacking, etc., and include unstable association between the terminal apparatus 200 and its parent node.

When the network connection of the terminal apparatus 200 is normally achieved (see ‘NO’ in the operation S805), the terminal apparatus 200 normally obtains an updated network key (i.e. the second network key) from the electronic apparatus 100 (S807). The terminal apparatus 200 transmits, to the electronic apparatus 100, the success response message in response to the reception of the updated network key, and this success response message includes the routing information of the terminal apparatus 200. The electronic apparatus 100 receives and updates the routing information of the terminal apparatus 200 based on the success response message, thereby synchronizing with the terminal apparatus 200 (S803).

When the network connection of the terminal apparatus 200 is unstable (see ‘YES’ in the operation S805), the terminal apparatus 200 cannot normally receive the periodically updated network key (i.e. the second network key) from the electronic apparatus 100.

For example, operating normally means that the operation is performed without an error occurring. For example, the normal operation of the terminal apparatus 200 is when the connection is stable and no loss of connection or interruption in connection occurs.

The electronic apparatus 100 receives a request for the second network key from the terminal apparatus 200 (S809). Here, the request for the second network key may be included in the request message for rejoining the network. In the operation S809, the rejoining request message may be transmitted as an unsecured message, and may be transmitted to the electronic apparatus 100 directly or via the router according to network structures. When the rejoining request message is transmitted through the router, the terminal apparatus 200 may regard the router as a new parent node and transmit the message to the new parent node.

In response to the request received in the operation S809, the electronic apparatus 100 generates a key based on the routing information (S811). Here, the routing information may be the routing information synchronized in the operation S803, and the generated key is used as the dynamic link key described with reference to FIG. 7.

The electronic apparatus 100 transmits the second network key encrypted by the key generated in the operation S811 to the terminal apparatus 200 (S813). Here, the second network key may be transmitted to the terminal apparatus 200 directly or via the router according to the network structures.

The terminal apparatus 200 receives and decrypts the second network key transmitted in the operation S813, thereby obtaining the second network key (S815).

Further, the terminal apparatus 200 and the electronic apparatus 100 terminate the dynamic link key generated in the operation S811, and the electronic apparatus 100 updates the routing information of the terminal apparatus 200 with a lastly received packet (S817).

Because the second network key transmitted and received in the operations S813 and S815 is encrypted with the dynamic link key by using the routing information of the terminal apparatus 200 as a parameter, none other than the electronic apparatus 100 and the terminal apparatus 200 can do decryption. Therefore, the second network key is much less likely to be leaked to the outside even though the packet is sniffed during the data transmission/reception procedures. Furthermore, the dynamic link key is terminated in the operation S817 when the transmission/reception of the corresponding network key is completed, and therefore not useable any more in any apparatus including the electronic apparatus 100 and the terminal apparatus 200, thereby enhancing security and facilitating network administration.

As described above, in the electronic apparatus, the terminal apparatus, the methods of controlling the same, and the computer program product thereof according to various embodiments, the network key is encrypted based on the key generated using the routing information of the terminal apparatus which wants to rejoin the wireless network, thereby having an effect of enhancing the security.

Further, in the electronic apparatus, the terminal apparatus, the methods of controlling the same, and the computer program product thereof according to various embodiments, the key is automatically terminated after transmitting the network key, and thus prevented from being leaked due to external hacking or the like.

Although a few embodiments have been shown and described, it will be appreciated by those skilled in the art that changes may be made in these embodiments without departing from the principles and spirit of the disclosure, the scope of which is defined in the appended claims and their equivalents.

What is claimed is:

1. An electronic apparatus comprising:
a communicator configured to communicate with a terminal apparatus via a network; and
a processor configured to:
receive, via the communicator, routing information of the terminal apparatus, and
based on a network key request received from the terminal apparatus, generate a link key based on the routing information, and transmit, to the terminal apparatus via the communicator, a network key encrypted with the generated link key such that the transmitted network key is decrypted, by the terminal apparatus, using the link key.

2. The electronic apparatus according to claim 1, wherein the processor is further configured to receive, via the communicator, a first network key and the routing information of the terminal apparatus, and to transmit, via the communicator, a second network key encrypted with the generated link key.

3. The electronic apparatus according to claim 1, wherein the processor is further configured to terminate the generated link key based on receiving from the terminal apparatus a response acknowledging a receipt of the transmitted network key.

4. The electronic apparatus according to claim 3, wherein:
the received response comprises updated routing information of the terminal apparatus, and
the processor is further configured to update the routing information to correspond to the updated routing information in the received response.

5. The electronic apparatus according to claim 1, wherein the routing information comprises:
link quality information indicating strength of a signal transmitted from and received by the terminal apparatus, and
depth information indicating a connection state of the terminal apparatus in a tree structure of the network.

6. The electronic apparatus according to claim 5, wherein:
the terminal apparatus is connected to the electronic apparatus through at least one router, and
the routing information further comprises identification information of the at least one router that performs an operation to relay between the terminal apparatus and the electronic apparatus.

7. A terminal apparatus comprising:
a communicator configured to communicate with an electronic apparatus through a network; and
a processor configured to:
transmit, via the communicator, routing information to the electronic apparatus,
request, via the communicator, a network key from the electronic apparatus,
receive, via the communicator, the network key encrypted with a link key generated based on the transmitted routing information, and
decrypt the received network key with the link key.

8. The terminal apparatus according to claim 7, wherein the processor is further configured to:
transmit, via the communicator, the routing information with a first network key,
receive, via the communicator, a second network key encrypted with the link key, and
decrypt the second network key with the link key.

9. The terminal apparatus according to claim 8, wherein the processor is further configured to:
request, via the communicator, the second network key from the electronic apparatus based on the terminal apparatus failing to perform communication using the first network key.

10. The terminal apparatus according to claim 7, wherein the processor is further configured to:
transmit, via the communicator to the electronic apparatus, a response indicating receipt of the network key, and
terminate the link key after the network key is obtained by the decryption and the response is transmitted.

11. The terminal apparatus according to claim 10, wherein the transmitted response comprises updated routing information of the terminal apparatus.

12. The terminal apparatus according to claim 7, wherein the routing information comprises:
link quality information indicating strength of a signal transmitted from and received by the terminal apparatus, and
depth information indicating a connection state of the terminal apparatus in a tree structure of the network.

13. The terminal apparatus according to claim 12, wherein:
the terminal apparatus is connected to the electronic apparatus through at least one router, and
the routing information further comprises identification information about the at least one router that performs an operation to relay between the terminal apparatus and the electronic apparatus.

14. The terminal apparatus according to claim 13, wherein the processor is configured to control the terminal apparatus to connect with the electronic apparatus through one router from among the at least one router selected based on the link quality information with respect to a plurality of surrounding network nodes.

15. A method of controlling an electronic apparatus, the method comprising:
receiving routing information from a terminal apparatus connected to a network;
based on receiving a request from the terminal apparatus, generating a link key based on the received routing information; and
transmitting, to the terminal apparatus, a network key encrypted with the generated link key such that the terminal apparatus decrypts the network key with the generated link key.

16. The method according to claim 15, wherein:
the receiving of the routing information comprises receiving, from the terminal apparatus, the routing information and a first network key, and
the transmitting of the network key comprises transmitting a second network key encrypted with the generated link key.

17. The method according to claim 15, further comprising terminating the generated link key based on receiving a response from the terminal apparatus with respect to the transmitted network key.

18. The method according to claim 17, wherein the received response comprises updated routing information of the terminal apparatus, and
wherein the method further comprises updating the routing information in accordance with the received response.

19. A method of controlling a terminal apparatus, the method comprising:
transmitting routing information to an electronic apparatus connected to a network;
requesting a network key from the electronic apparatus;
receiving, from the electronic apparatus, the network key encrypted with a link key generated based on the transmitted routing information; and
obtaining the network key by decrypting the received network key with the link key.

20. A computer program product comprising:
a memory configured to store an instruction; and
a processor,
wherein the instruction cause the processor to:
receive routing information of a terminal apparatus connected to a network,
based on a network key request from the terminal apparatus, generate a link key based on the received routing information, and
transmit, to the terminal apparatus, a network key encrypted with the generated link key such that the terminal apparatus decrypts the transmitted network key with the link key.
